(19) United States
(12) Patent Application Publication
(10) Pub. No.: US 2007/0124295 A1
(43) Pub. Date: May 31, 2007

(54) Systems, methods, and media for searching documents based on text characteristics

(76) Inventors: Ira R. Forman, Austin, TX (US); Lane T. Holloway, Pflugerville, TX (US); Walid Kobrosly, Round Rock, TX (US); Nadeem Malik, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/289,096

(22) Filed: Nov. 29, 2005

(51) Int. Cl. G06F 17/30

(52) U.S. Cl. 707/4

(57) ABSTRACT

Systems, methods and media for searching documents based on text characteristics are disclosed. Embodiments may include receiving by a document searching system a request to search a document for a keyword and to limit the search based on one or more text characteristics associated with the keyword. Embodiments may also include performing by the document searching system a search of the document based on the keyword and the one or more associated text characteristics to find an instance of the keyword and generating by the document searching system a search result based on the performed document search. The text characteristics in some embodiments may include one or more of font style information, font emphasis information, highlighting information, or color information. In some embodiments, performing the search of the document includes finding an instance of the keyword where the keyword has characteristics that match at least one associated text characteristic.

### FIELD OF INVENTION

The present invention is in the field of data processing systems and, in particular, to systems, methods and media for searching electronic documents based on text characteristics.

### BACKGROUND

Personal computer systems are well known in the art. They have attained widespread use for providing computer power to many segments of today's modern society. Personal computers (PCs) may be defined as a desktop, floor standing, or portable microcomputer that includes a system unit having a central processing unit (CPU) and associated volatile and non-volatile memory, including random access memory (RAM) and basic input/output system read only memory (BIOS ROM), a system monitor, a keyboard, one or more flexible diskette drives, a CD-ROM or DVD-ROM drive, a fixed disk storage drive (also known as a “hard drive”), a pointing device such as a mouse, and an optional network interface adapter. One of the distinguishing characteristics of these systems is the use of a motherboard or system planar to electrically connect these components together. The use of mobile computing devices, such as notebook PCs, personal digital assistants (PDAs), sophisticated wireless phones, etc., has also become widespread. Mobile computing devices typically exchange some functionality or performance when compared to traditional PCs in exchange for smaller size, portable power, and mobility.

A primary use of PCs, and one that continues to increase in importance, is to utilize a PC to access information stored in an electronic document. Applications such as word processors, text editors, document readers, browsers, and spreadsheets allows users to view (and possibly edit) information stored in electronic documents (including document files or Internet/intranet web pages). Often a user desires to find a specific item or type information in the document and does not wish to read the entire document. As documents can be hundreds or even thousands of pages long, reading the entire document to find the information for which the user is looking can often be a time-consuming and inefficient process.

Accordingly, most applications for viewing documents have a search function that allows a user to input a keyword and linearly view each instance of the keyword in the document until they find the instance for which they are searching. A user, for example, could enter a keyword and select a ‘find next’ or comparable search button to find the first instance of the keyword in the document. If that instance did not provide them with all the information they were looking for, the user could select ‘find next’ again to access the next instance, and so on, until the user found the desired information. If the keyword is found in many places within the document, the user may need to select and view many instances of the keyword (and its surrounding text) to complete their task. The traditional search function therefore does not provide a satisfactory solution in all cases as users often need to review many instances of a keyword to find the information for which they are looking, reducing the user's efficiency.

There is, therefore, a need for an efficient and effective mechanism for searching documents, particularly for longer documents.

### SUMMARY OF THE INVENTION

The problems identified above are in large part addressed by systems, methods and media for searching documents based on text characteristics. Embodiments may include receiving by a document searching system a request to search a document for a keyword and to limit the search based on one or more text characteristics associated with the keyword. Embodiments may also include performing by the document searching system a search of the document based on the keyword and the one or more associated text characteristics to find an instance of the keyword and generating by the document searching system a search result based on the performed document search. A further embodiment may also include displaying the search result. The text characteristics in some embodiments may include one or more of font style information, font emphasis information, highlighting information, or color information.

Another embodiment provides a machine-accessible medium containing instructions effective, when executing in a data processing system, to cause the system to perform a series of operations for searching a document. The series of operations generally includes receiving by a document searching system a request to search a document for a keyword and to limit the search based on one or more text characteristics associated with the keyword. Embodiments may also include a series of operations for performing by the document searching system a search of the document based on the keyword and the one or more associated text characteristics to find an instance of the keyword and a series of operations for generating by the document searching system a search result based on the performed document search. A further embodiment may also include a series of operations for displaying the search result.

A further embodiment provides a document searching system. The document searching system may generally include a reader user interface module to receive a request from a user to search a document based on a keyword and one or more text characteristics associated with the keyword. The document searching system may also generally include a search module in communication with the reader user interface module to search the document based on the keyword to generate search results and a text characteristic search module to cooperate with the search module to limit the search results based on the one or more text characteristics associated with the keyword to be searched. In a further embodiment, the reader user interface module, the search module, and the text characteristic search module are integrated into a document reader.

### BRIEF DESCRIPTION OF THE DRAWINGS

Other advantages of the invention will become apparent upon reading the following detailed description and upon reference to the accompanying drawings in which, like references may indicate similar elements:

FIG. 1 depicts a conceptual illustration of software components for a document searching system with a text characteristic search module according to one embodiment;

FIG. 2 depicts a block diagram of one embodiment of a computer system suitable for executing the operations of the document searching system;

FIG. 3 depicts an example of a flow chart for performing a search based on a keyword and associated text characteristics according to one embodiment; and

FIG. 4 depicts an example of a user interface for text characteristic document searching according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

Systems, methods and media for searching documents based on text characteristics are disclosed. Embodiments may include receiving by a document searching system a request to search a document for a keyword and to limit the search based on one or more text characteristics associated with the keyword. Embodiments may also include performing by the document searching system a search of the document based on the keyword and the one or more associated text characteristics to find an instance of the keyword and generating by the document searching system a search result based on the performed document search. The text characteristics in some embodiments may include one or more of font style information, font emphasis information, highlighting information, or color information. In some embodiments, performing the search of the document includes finding an instance of the keyword where the keyword has characteristics that match at least one associated text characteristic.

The system and methodology of the disclosed embodiments provides for an effective and efficient way of searching an electronic document. By limiting a keyword search of a document based on one or more text characteristics, a user may efficiently find information for which they are looking in a document by effectively ‘focusing’ the search. In many cases, a user may perform a keyword search to look for information when they know something about the characteristics of the keyword and how it appears in the document. If the user knows, for example, that the keyword instance they are looking for is in a blue font (e.g., they saw it before, it is a section heading and section headings are blue, etc.) they can accordingly limit their search in that way to skip over keyword instances with different colored fonts. By allowing a user to focus a keyword search based on text characteristics, the user may more effectively search a document for information they desire and eliminate the need to review search results containing keywords without the requested characteristics.

While specific embodiments will be described below with reference to particular configurations of hardware and/or software, those of skill in the art will realize that embodiments of the present invention may advantageously be implemented with other substantially equivalent hardware and/or software systems. Aspects of the invention described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the invention are also encompassed within the scope of the invention.

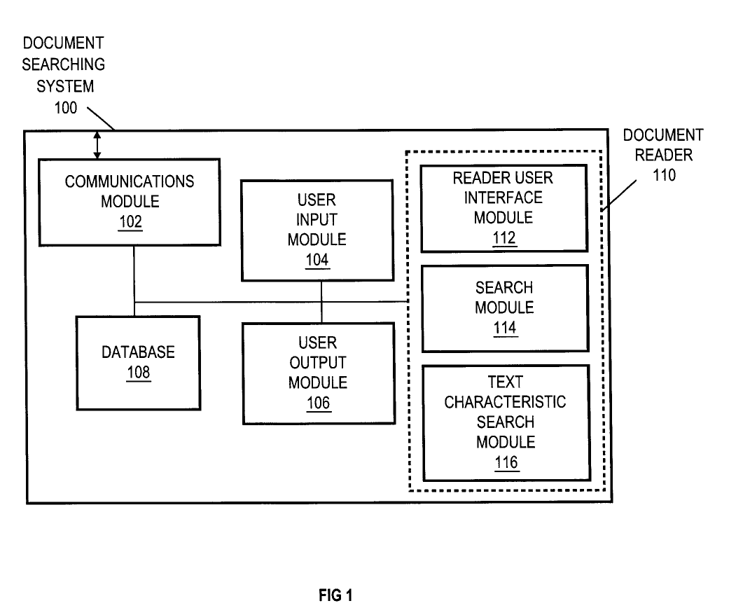

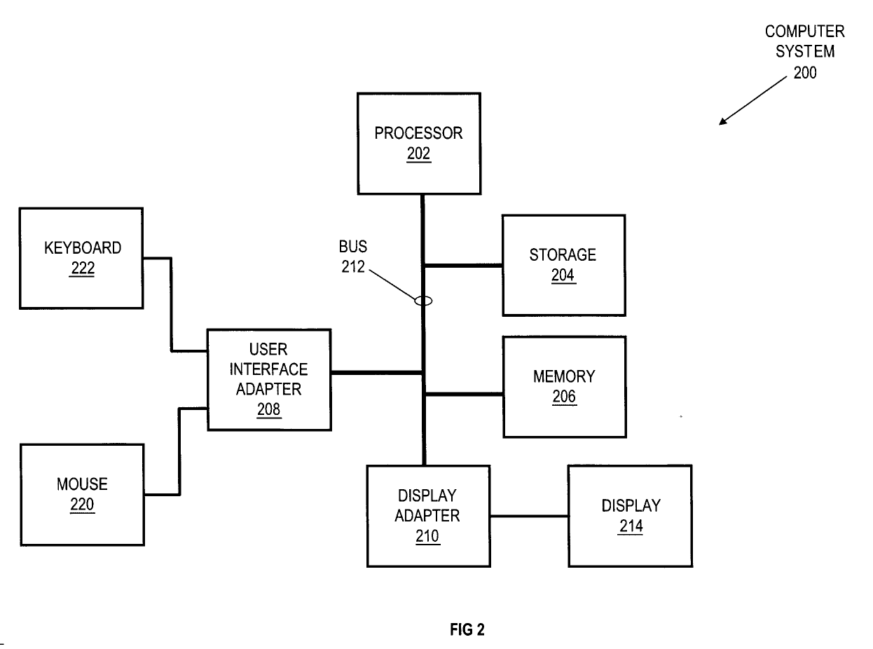

Turning now to the drawings, FIG. 1 depicts a conceptual illustration of software components for a document searching system with a text characteristic search module according to one embodiment. In the depicted embodiment, the document searching system 100 includes a communications module 102, a user input module 104, a user output module 106, a database 108, and a document reader 110. The document searching system 100 may execute on one or more personal computers, workstations, servers, mainframe computers, notebook or laptop computers, desktop computers, PDAs, set-top boxes, mobile phones, wireless devices, or other systems. In some embodiments, the document searching system 100 may execute on a computer system as described in relation to FIG. 2. The document searching system 100 may be in wired or wireless communication with a network, such as the Internet, an intranet, a local area network (LAN), a wide area network (WAN), an Ethernet network, a wireless network, a proprietary network, a broadband cable network, or any other data communication channel. As will be described in more detail subsequently, a user may utilize the document searching system 100 to search documents based on text characteristics in addition to being able to search based on keywords.

The communications module 102 may facilitate communications to and from the document searching system 100 via a network. The user interface module 304 may receive user input from user input devices such as a mouse or keyboard while the user output module 106 may provide output to a user, such as via a display, printer or speaker. Database 108 may store any type of information, including searchable documents or user preferences.

The document reader 110 may facilitate viewing or reading of an electronic document as well as providing for searching of electronic documents. In an alternative embodiment, the document reader 110 may also provide for editing of electronic documents. Electronic documents, known simply herein as documents, may be any electronic file or page that includes one or more words that may be searched. Documents may include text documents, documents specific to a particular application (e.g., word processor, spreadsheet, document reader, etc.), universal document formats (e.g., Rich Text Format (RTF), Adobe Corporation's Adobe Portable Document Format (PDF), etc.) file, web pages (in hypertext markup language (HTML) or other format), etc.

Document reader 110 may be any type of application allowing a user to view a document, including word processors (e.g., a modified version of Microsoft Corporation's Microsoft® Word™), spreadsheets (e.g., a modified version of Microsoft Corporation's Microsoft® Excel™), readers (e.g., a modified version of Adobe Corporation's Adobe® Reader™), or other applications. Document reader 110 may be a graphical browser in another embodiment, such as modified versions of Microsoft Corporation's Internet Explorer™, Netscape Communication Corporation's Navigator™, Mozilla Foundation's Mozilla, Apple Corporation's Safari™, etc. Browsers, at their most basic level of operation, permit users to connect to a given network site, download informational content from that site, and display that information to the user. To view additional information, the user designates a new network address (such as by selecting a link) whose contents then replace the previously displayed information on the user's computer display. Using a document reader 110 according to the disclosed embodiments, a user may access a document and search the document using a combination of keywords and text characteristics associated with those keywords.

The document reader 110 may include sub-modules such as a reader user interface module 112, a search module 114, or a text characteristic search module 116. The reader user interface module 112 may facilitate a user in accessing and viewing a document as is generally known in the art. Upon receiving a request from a user via the user input module 104 to access a document, for example, the reader user interface module 112 may open the file stored in database 108 and display the document to the user via the user output module 106. The reader user interface module 112 may optionally allow a user to scroll through a document, change the viewing size of the document, edit the document, or perform other types of tasks on or utilizing the document. The search module 114 may allow a user to search a document opened by the reader user interface module 112. The search module 114 may, in one embodiment, allow a user to enter a keyword, after which the search module 114 may search the document for the first (or next) instance of that keyword. Once the keyword instance is found, the search module 114 may in one embodiment provide the location of the keyword by changing the view of the document to show the keyword instance and highlight or otherwise identify the keyword. This allows the user to see the keyword and any text surrounding or adjacent the keyword so that the user may determine whether additional searching is required. In some embodiments, a user may select additional searching (such as by selecting a ‘find next’ or other search button) to find subsequent instances of the keyword in the document.

The document reader 110 may also advantageously include the text characteristic search module 116 to provide additional search capabilities. The text characteristic search module 116 of the disclosed embodiments may allow a user to associate one or more text characteristics with a keyword before performing a search and may then perform the search to produce results that include instances of the keyword has text characteristics that match the selected text characteristics. Text characteristics may include any attributes of a keyword (or characters in a keyword) such as one or more of font style information, font emphasis information, highlighting information, or color information. Font style information may include the identity of the font, font size, superscript or subscript information, etc. Font emphasis information may include underlining, boldfacing, italicizing, small caps, outline, shadow, emboss, engrave, strikethrough, double-strikethrough, etc., or other means of emphasizing or distinguishing text. Highlighting information may include whether or not the keyword is highlighted and the color of highlighting. Color information may include the color of the font or the color of the background. One skilled in the art will recognize that other types of text characteristics are possible and within the scope of the invention. The text characteristic search module 116 may work in conjunction with the search module 114 to perform some or all of its tasks in some embodiments.

Utilizing the text characteristic search module 116, a user may therefore efficiently search a document by limiting their search to particular text characteristics. A user who selected a keyword and specified ‘red’ and ‘boldface’ for text characteristics, for example, would only be presented with results that met those characteristics. Other instances of the keyword that were not both ‘red’ or ‘boldface’ would not presented as search results. This may prove particularly useful for a user when the user knows certain characteristics about the text they wish to find. For example, if a user desired to find the word ‘camera’ in a chapter title of a document, and the user knew that titles in the document were boldfaced, the user could search for a boldface instance of ‘camera’ to quickly and efficiently find the desired chapter. In many cases, this could save the user of this example having to repeatedly acquire and reject search results that were not boldfaced.

One skilled in the art will recognize that the text characteristic search module 116 may operate in different fashions. In one embodiment, a user may search for multiple keywords and specify particular text characteristics for each keyword. For example, the user may search for ‘keyword1’ in boldface in the same sentence as ‘keyword2’ in a red font. In another embodiment, the user may select text characteristics in the alternative, such as by specify that the keyword should be ‘red’ or ‘boldface’ instead of ‘red’ and ‘boldface’. In another alternative embodiment, the user may search for keywords where only some of the letters of the keyword have a particular text characteristic, such as by searching for a keyword where the first letter is at a particular font size.

In an alternative embodiment, the text characteristic search module 116 may be an add-on or stand-alone application separate from the document reader 110 instead of being incorporated into the document reader 110. In this embodiment, the text characteristic search module 116 may be provided by a third party or other vendor and be designed to provide additional functionality to existing document readers.

FIG. 2 depicts a block diagram of one embodiment of a computer system 200 suitable for executing the operations of the document searching system 100. Other possibilities for the computer system 200 are possible, including a computer having capabilities other than those ascribed herein and possibly beyond those capabilities, and they may, in other embodiments, be any combination of processing devices such as workstations, servers, mainframe computers, notebook or laptop computers, desktop computers, PDAs, mobile phones, wireless devices, set-top boxes, or the like. At least certain of the components of computer system 200 may be mounted on a multi-layer planar or motherboard (which may itself be mounted on the chassis) to provide a means for electrically interconnecting the components of the computer system 200.

In the depicted embodiment, the computer system 200 includes a processor 202, storage 204, memory 206, a user interface adapter 208, and a display adapter 210 connected to a bus 212. The bus 212 facilitates communication between the processor 202 and other components of the computer system 200, as well as communication between components. Processor 202 may include one or more system central processing units (CPUs) or processors to execute instructions, such as an IBM® PowerPC™ processor, an Intel Pentium® processor, an Advanced Micro Devices Inc. processor or any other suitable processor. The processor 202 may utilize storage 204, which may be non-volatile storage such as one or more hard drives, tape drives, diskette drives, CD-ROM drive, DVD-ROM drive, or the like. In some embodiments, documents to be searched may be stored in storage 204. The processor 202 may also be connected to memory 206 via bus 212, such as via a memory controller hub (MCH). System memory 206 may include volatile memory such as random access memory (RAM) or double data rate (DDR) synchronous dynamic random access memory (SDRAM).

The user interface adapter 208 may connect the processor 202 with user interface devices such as a mouse 220 or keyboard 222. The user interface adapter 208 may also connect with other types of user input devices, such as touch pads, touch sensitive screens, electronic pens, microphones, etc. In some embodiments, a user may select keywords and text characteristics using user input devices such as the mouse 220 or keyboard 222. The bus 212 may also connect the processor 202 to a display 214, such as an LCD display or CRT monitor, via the display adapter 210. Search results may be displayed to a user utilizing a display 214 in some embodiments.

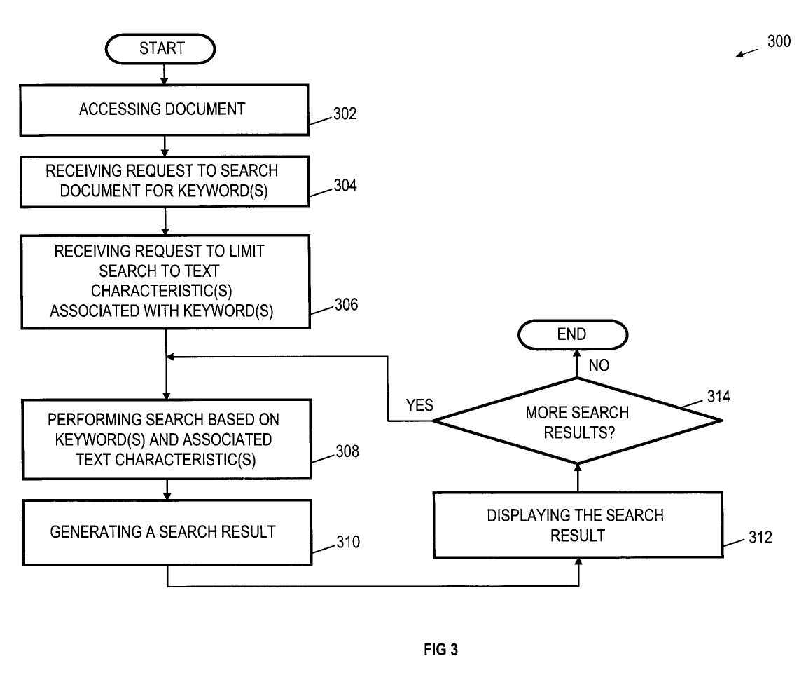

FIG. 3 depicts an example of a flow chart for performing a search based on a keyword and associated text characteristics according to one embodiment. In one embodiment, components of a document searching system 100 such as the text characteristic search module 116 may perform the elements of flow chart 300. In the depicted embodiment, flow chart 300 begins with element 302, accessing a document. In one embodiment, a reader user interface module 112 may access a document stored in database 108 at element 302, such as in response to a user request to access, or open, the document. A user may request access to a document if they desire to access the contents of the document. Once a document is open, the reader user interface module 112 may receive a request to search the document for one or more keywords at element 304. At element 306, the reader user interface module 112 may also receive a request to limit the document search to one or more text characteristics associated with the keyword(s). The request may include, in one example, text characteristics of a color and ‘boldface’ so that the search will be limited to instances of the keyword that have those text characteristics. A user may request that a keyword have all of the selected text characteristics, a subset of the selected text characteristics, or at least one of the selected text characteristics. In another alternative embodiment, the user may request different text characteristics for multiple keywords simultaneously. This allows for a user to further customize the search by designating different text characteristics for different keywords (e.g., search for keyword1 in boldface and keyword2 in a ‘Times Roman’ font). In yet another alternative embodiment, the user may designate the applicability of text characteristics to only certain letters of a keyword, such as by limiting the search to instances of the keyword where the first letter is above a certain font size.

In an alternative embodiment, the keyword may be blank so that the text of the document is searched for the first instance of the requested text characteristics on any text. In other words, no keyword need be entered and the search results will then include the next instance of those text characteristics regardless of the particular text associated with them. This may be particularly useful for a user, for example, desiring to find the use of text characteristics in a document. For instance, a user could search for any italicized text (or highlighted text, or red boldface text, etc.) in the document and receive the search results including the use of the text characteristics with any letter, keyword, etc.

After receiving a request to search a document for a keyword and to limit that search by one or more text characteristics, the method of flow chart 300 may continue to element 308, where the text characteristic search module 116, optionally in conjunction with the search module 114, may perform a search based on the keyword(s) and any associated text characteristics to find an instance of the keyword. The text characteristic search module 116 may accordingly limit a traditional keyword search based on the one or more requested text characteristics. The found keyword instance may be the first instance in the document, the next instance after a current cursor or viewing location, or other instance. At element 310, the text characteristic search module 116 may generate a search result and display that search result at element 312. In performing elements 310 and 312, the text characteristic search module 116 may work in conjunction with the search module 114 and the user output module 106, respectively. The search result may, in some embodiments, be the first instance in the document of the keyword that matches the requested text characteristics. In other embodiments (or upon repeated executions of flow chart 300), the search result may be the next instance in the document of the keyword matching the requested text characteristics, such as the next instance after a current cursor location within the document or the next instance after the previously displayed instance. The search result may also include text adjacent to (before and/or after) the keyword instance to provide additional information to the user. In some embodiments, the search result may be an action to move the user's location in the document to the location of the found instance.

At decision block 314, the text characteristic search module 116 may determine whether to provide more search results for additional instances of the keyword. In one embodiment, the text characteristic search module 116 may determine to provide more search results in response to receiving a request for more results from a user. This may occur, for example, when a user reviews the search results and requests (e.g., via a ‘find next’ or other search button) more results. If more search results will be provided, the method of flow chart 300 returns to element 308 for additional searching. If no more searching is required, the method of flow chart 300 may simply terminate.

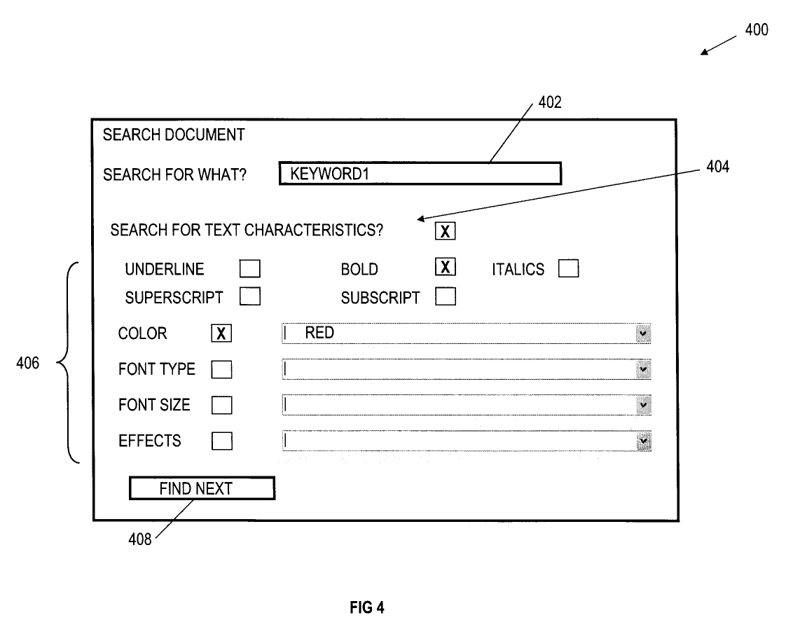

FIG. 4 depicts an example of a user interface for text characteristic document searching according to one embodiment. The searching user interface 400 may be generated by the user output module 106 in response to a request from the document reader 110 and/or text characteristic search module 116. Using the searching user interface 400, a user may select a keyword and one or more text characteristics associated with that keyword. The user may, for example, input a keyword in the keyword field 402 to provide the basis for the search. The user may also request that the keyword search be limited by text characteristics by, for example, selecting a text characteristics active box 404 in the searching user interface 400. Selecting the text characteristics active box 404 may allow the user to input different text characteristics, as described subsequently.

The searching user interface 400 may also include one or more text characteristics selectors 406. Using the text characteristics selectors 406, a user may select the one or more characteristics they desire to be associated with the keyword they input in the keyword field 402. The text characteristics selectors 406 may be in any format, such as pull down menus, selectable boxes, etc. The searching user interface 400 may also include a search button 408 that allows a user to, upon actuation or selection, request a search for the next keyword that satisfies the selected text characteristics. In some embodiments, a user may continue to actuate the search button 408 until the desired search results appear. While one embodiment of the searching user interface 400 is described in FIG. 4, one skilled in the art will recognize that the searching user interface 400 may have any configuration or design and may include any type of options or text characteristics selectors 406.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for searching documents based on text characteristics. It is understood that the form of the invention shown and described in the detailed description and the drawings are to be taken merely as examples. It is intended that the following claims be interpreted broadly to embrace all the variations of the example embodiments disclosed.

What is claimed is:

1. A computer-implemented method for searching a document, the method comprising:
receiving by a document searching system a request to search a document for a keyword and to limit the search based on one or more text characteristics associated with the keyword;
performing by the document searching system a search of the document based on the keyword and the one or more associated text characteristics to find an instance of the keyword; and
generating by the document searching system a search result based on the performed document search.

2. The method of claim 1, further comprising displaying the search result.

3. The method of claim 1, wherein the one or more text characteristics comprise one or more of font style information, font emphasis information, highlighting information, or color information.

4. The method of claim 1, wherein the document comprises one or more of a text document, an application-specific document, a universal document format file, or a web page.

5. The method of claim 1, wherein performing the search of the document based on the keyword and the one or more associated text characteristics comprises performing the search of the document by finding an instance of the keyword where the keyword has characteristics that match all of the one or more associated text characteristics.

6. The method of claim 1, wherein performing the search of the document based on the keyword and the one or more associated text characteristics comprises performing the search of the document by finding an instance of the keyword where the keyword has characteristics that match at least one of the one or more associated text characteristics.

7. The method of claim 1, wherein the search result comprises the keyword instance and text located adjacent the keyword.

8. The method of claim 1, wherein the keyword is blank.

9. A machine-accessible medium containing instructions effective, when executing in a data processing system, to cause said data processing system to perform operations comprising:
receiving by a document searching system a request to search a document for a keyword and to limit the search based on one or more text characteristics associated with the keyword;
performing by the document searching system a search of the document based on the keyword and the one or more associated text characteristics to find an instance of the keyword; and
generating by the document searching system a search result based on the performed document search.

10. The machine-accessible medium of claim 9, further comprising displaying the search result.

11. The machine-accessible medium of claim 9, wherein the one or more text characteristics comprise one or more of font style information, font emphasis information, highlighting information, or color information.

12. The machine-accessible medium of claim 9, wherein the document comprises one or more of a text document, an application-specific document, a universal document format file, or a web page.

13. The machine-accessible medium of claim 9, wherein performing the search of the document based on the keyword and the one or more associated text characteristics comprises performing the search of the document by finding an instance of the keyword where the keyword has characteristics that match at least one of the one or more associated text characteristics.

14. The machine-accessible medium of claim 9, wherein the search result comprises the keyword instance and text located adjacent the keyword.

15. A document searching system, the system comprising:
a reader user interface module, the reader user interface module being adapted to receive a request from a user to search a document based on a keyword and one or more text characteristics associated with the keyword;
a search module in communication with the reader user interface module, the search module being adapted to search the document based on the keyword to generate search results; and
a text characteristic search module in communication with the search module, the text characteristic search module being adapted to cooperate with the search module to limit the search results based on the one or more text characteristics associated with the keyword to be searched.

16. The system of claim 15, wherein the reader user interface module, the search module, and the text characteristic search module are integrated into a document reader.

17. The system of claim 16, wherein the document reader comprises one or more of a browser, a word processor, a spreadsheet, or a reader.

18. The system of claim 15, wherein the one or more text characteristics comprise one or more of font style information, font emphasis information, highlighting information, or color information.

19. The system of claim 15, wherein the document comprises one or more of a text document, an application-specific document, a universal document format file, or a web page.

20. The system of claim 15, wherein the system is adapted to execute on one or more of a personal computer, workstation, server, mainframe computer, notebook computer, laptop computer, desktop computer, personal digital assistant, set-top box, mobile phone, or wireless device.
